(19) United States
(12) Patent Application Publication
(10) Pub. No.: US 2009/0172106 A1
(43) Pub. Date: Jul. 2, 2009

(54) Method and Apparatus to Facilitate Provision and Use of a Media Source Bundle

(75) Inventors: Dongge Li, Hoffman Estates, IL (US); Bhavan Gandhi, Vernon Hills, IL (US); Cuneyt Taskiran, Chicago, IL (US); Wei Wang, Barrington, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/965,084

(22) Filed: Dec. 27, 2007

(51) Int. Cl. G06F 15/16

(52) U.S. Cl. 709/206

(57) ABSTRACT

One provides (101) a media source bundle (200) as pertains to a given subject matter of interest to at least one end user. This media source bundle can comprise, for example and at least in part, content source locations for each of a plurality of independent content sources that each offer content regarding the given subject matter and wherein at least some of these independent content sources are associated with mutually non-compatible electronic content-delivery modalities. (In such an application, the media source bundle will be understood to not comprise the content itself.) These teachings will then provide for transmitting (102) a message that comprises, at least in part, this media source bundle to one or more corresponding end user recipient platforms (303).

### TECHNICAL FIELD

This invention relates generally to transmissible media and more particularly to multiple transmissible media items as pertain in common to a given subject matter.

### BACKGROUND

Modem times are sometimes referred to as the Age of Information. Indeed, subject matter of virtually every description can be found in a wide (and seemingly ever growing) variety of formats. This can readily include text-only formats, still image formats, moving image formats, audio content, audio visual content, and so forth. This can further readily include content offered via a wide variety of non-compatible electronic content-delivery modalities. Examples in this regard would include, but are not limited to, Internet Protocol-based streaming content, Internet Protocol-based file transfer content, television broadcasts (using any of a variety of available broadcasting standards), radio broadcasts (again using any of a variety of available broadcasting standards), short message services and other email-like services, portable physical media-based content (such as digital video discs (DVDs))and so forth.

The availability of such a wealth of material holds considerable promise, but the typical end user experience often falls far short of realizing the implied opportunities. As one example in this regard, a variety of incompatible delivery modalities are available and this can cause confusion with respect to issues of compatibility. A given end user, for example, might wish to consume a given item of media content but find this impossible due to an inability of the end user's rendering platforms to compatibly receive and process the media content in question. Generally speaking, as things stand, content experiences cannot easily cross end-user rendering platforms, time, and/or location in a way that facilitates, rather than frustrates, the end user experience.

As another example in this regard, in many cases a given end user will have a particular subject matter of interest. To locate corresponding media that relates to that subject matter of interest, however, the end user must often explore and investigate the available rendering opportunities in a piecemeal manner. For example, the end user must consult a television broadcast guide in order to locate televised media content that deals with this subject matter and must then also consult some other source in order to identify rendering opportunities that may be available via the Internet. There are any number of problems, faults, and inconveniences that typically burden such an approach.

### BRIEF DESCRIPTION OF THE DRAWINGS

The above needs are at least partially met through provision of the method and apparatus to facilitate provision and use of a media source bundle described in the following detailed description, particularly when studied in conjunction with the drawings, wherein:

FIG. 1 comprises a flow diagram as configured in accordance with various embodiments of the invention;

FIG. 2 comprises a schematic diagram as configured in accordance with various embodiments of the invention;

FIG. 3 comprises a block diagram as configured in accordance with various embodiments of the invention;

FIG. 4 comprises a flow diagram as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a media source bundle as pertains to a given subject matter of interest to at least one end user. This media source bundle can comprise, for example and at least in part, content source locations for each of a plurality of independent content sources that each offer content regarding the given subject matter and wherein at least some of these independent content sources are associated with mutually non-compatible electronic content-delivery modalities. (In such an application, the media source bundle will be understood to not comprise the content itself.) These teachings will then provide for transmitting a message that comprises, at least in part, this media source bundle to one or more corresponding end user recipient platforms.

By one approach, this media source bundle can further comprise relationship information that characterizes a given subject matter-based relationship as between at least two items of the content. This can serve, for example, to inform the end user with respect to making decisions regarding accessing particular items of the content. These might comprise, for example, temporally-based subject matter-based relationships and/or semantically-related subject matter-based relationships, to note but two examples in this regard.

Also by one approach, if desired, this media source can further comprise providing a media source bundle that also comprises at least one metadata source location as corresponds to at least one remote metadata source for metadata as corresponds to at least some of the content. Such an approach can serve, in turn, to greatly increase the opportunities for an end user to access supplemental information regarding the media consumption options without burdening the initial message with unnecessary (that is, unneeded) content.

So configured, those skilled in the art will recognize and appreciate that an end user can be readily supplied with a quantity of information to thereby assist that end user in making informed choices regarding the consumption of media content from any of a variety of independent content sources in a manner that best accommodates their present consumption circumstances and interests. These teachings are readily leveraged using existing protocols, message formats, and media delivery modalities. These teachings are also readily scalable and can accommodate a widely varying number of content sources, delivery modalities, subject matters, and so forth in a cost effective and efficient manner. These teachings will also accommodate usage in a highly automated process where such is available.

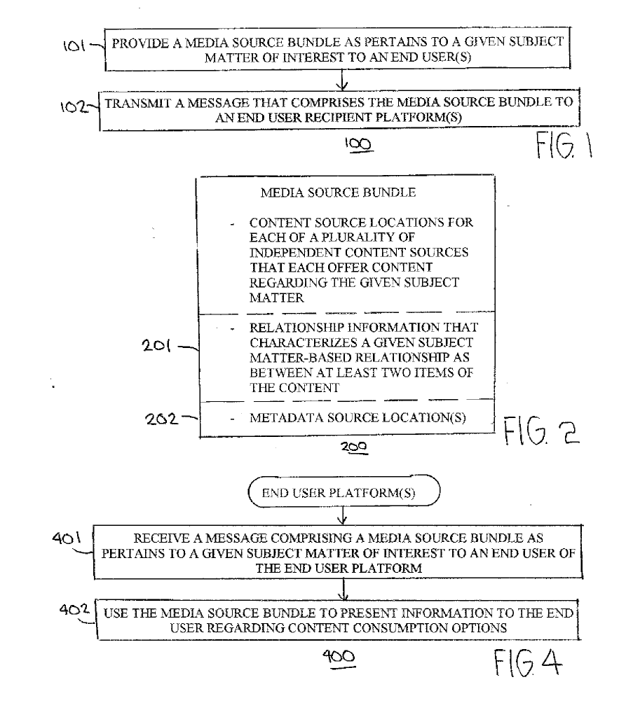

These and other benefits may become clearer upon making a thorough review and study of the following detailed description. Referring now to the drawings, and in particular to FIG. 1, an illustrative process that is compatible with many of these teachings will now be presented. Pursuant to this process 100, one provides 101 a media source bundle as pertains to a given subject matter of interest to at least one end user. Depending upon the needs and/or opportunities that tend to characterize a given application setting, this step 101 can be in response to prompting from the end user, a content service provider, a party affiliated with the subject matter, and so forth (with other possibilities existing as well).

These teachings are not particularly sensitive with respect to the nature of the subject matter itself. Generally speaking, these teachings are applicable for use with any of a wide range of subject matters. Examples in this regard include, but are not limited to, subject matters related to entertainment, education, business, research, archival, and other purposes of choice or interest. Those skilled in the art will further understand and appreciate that the subject matter can range from being broad in scope (for example, “sports”) to a more narrow emphasis (for example, a particular sport, team, event, player, or the like).

The media source bundle so provided does not comprise the content itself. Instead, and referring momentarily to FIG. 2, the media source bundle 200 comprises data containing, at least in part, content source locations for each of a plurality of independent content sources that each offer content regarding the given subject matter. (As used herein, “independent” will be understood to refer to physical independence such that the content sources are physically unrelated to one another and hence do not share, for example, a common physical carrier for the content source location data.)

It will further be understood that at least some of these independent content sources are associated with mutually non-compatible electronic content-delivery modalities. Examples in this regard include television broadcast transmissions, radio broadcast transmissions (such as government regulated commercial AM and FM radio broadcasts), packet data-based streaming video-only transmissions, packet data-based streaming audio-only transmissions, packet data-based streaming audio/visual transmissions, short message service (SMS) text transmissions, packet data-based hypertext transfer markup language (HTML)-based resources (such as World Wide Web (WWW) server-based browser-accessed resources), and so forth.

The content source location information will of course vary with the electronic content-delivery modality of the various content sources. When the content source comprises a licensed television broadcaster, the corresponding content source location may comprise a particular reception frequency along with, for example, some identifier to specify a particular reception standard to be employed to ensure compatible reception and processing of the received transmission. As another example, when the content source comprises a particular website, the corresponding content source location may comprise a particular uniform resource locator (URL) that identifies an Internet address at which the content source can be accessed.

The media source bundle 200 can contain additional information if desired. By one approach, for example, the media source bundle 200 can further comprise relationship information 201 that characterizes a given subject matter-based relationship as between at least two items of the content. Such relationship information can serve, in turn, to inform an end user with respect to making decisions regarding accessing particular items of the content. As one example in this regard, this relationship information can comprise a temporally-related subject matter-based relationship. By way of illustration and not by way of limitation, a first item of content can be identified as comprising information regarding a particular date in time while a second item of content can be identified as comprising information regarding a different, latter date in time. Such information can be used by an end user to decide, for example, a particular sequential order in which to consume the corresponding content from these content sources.

As another non-limiting example, such relationship information can comprise a semantically-related subject matter-based relationship. [note to inventors—can you please provide one or two good examples in this regard?]

As another example of additional information that can optionally be included in the media source bundle 200, the latter can also comprise one or more metadata source locations 202 as correspond to at least one remote metadata source for metadata as corresponds to at least some of the content. (Those skilled in the art will understand that, as used herein, the expression “remote” refers to a location other than within and native to the corresponding end user platform.) This metadata can comprise, for example, additional characterizing information regarding the content itself. Examples include, but are not limited to, technical metadata (such as information regarding a duration of time required to fully consume the content, file size, an applicable content encoding/decoding standard required to receive and/or render the content, and so forth), supplemental content description (such as information summarizing the substance of the content, critical reviews, thumbnail graphics, video trailers, and so forth), consumption statistics (such as information regarding relative popularity of the content source and/or the content itself), and so forth. [note to inventors—any other metadata examples that you would like to add?]

The precise form of the media source bundle can vary with the needs and/or opportunities as tend to characterize a given application setting. For example, by one approach, this media source bundle can comprise a single integral packet of information. By another approach, this bundle can be parsed over a plurality of associated packets. The information items themselves can be segregated from or interleaved with one another as desired. It will also be understood that the media source bundle can be partially or fully encrypted or encoded as desired. It will also be understood that this media source bundle can comprise other less-related content items as well. For example, the media source bundle may also include commercial content such as advertising for one or more products or services that may or may not related to the given subject matter of interest.

Referring again to FIG. 1, this process 100 will then accommodate transmitting 102 a message that comprises, at least in part, this media source bundle to at least one end user recipient platform. This may comprise, in an appropriate application setting, transmitting a given media source bundle to each of a plurality of platforms for a given end user (such as, for example, a portable Personal Digital Assistant (PDA), a cellular telephone, an office desktop computer, a home media center, an in-vehicle content rendering platform, and so forth, as may each belong to or be controlled or utilized by this end user). The modality of the transmission itself can of course vary with respect to the application setting and may comprise, for example, any variety of wireless and/or wireline transmission (including transmissions that rely upon an electromagnetic carrier as well as optical or sonic carriers, all being well known and understood in the art).

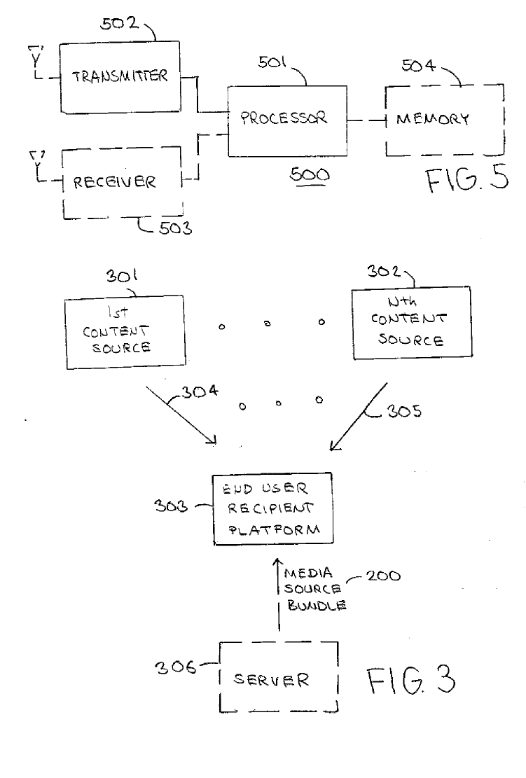

As a simple illustrative example in these regards, and without any intention to limit the scope of these teachings, in FIG. 3 a plurality of content sources (denoted here as a first content source 301 through an Nth content source 302 (where “N” will be understood to comprise an integer greater than “1”) may each be independent of one another and may each offer content that pertains to a given subject matter of interest to an end user. Such content may be obtainable on a scheduled basis (such as a television transmission) or may be available on an as-accessed basis (such as much streaming packet data content).

The aforementioned end user may, in turn, have an end user recipient platform 303 that is capable, in this example, of compatibly receiving and rendering such content. For example, this end user recipient platform 303 is configured and arranged to compatibly receive content from the first content source 301 as may be transmitted using a first electronic content-delivery modality 304 and to compatibly receive content from the Nth content source 302 as may be transmitted using a second electronic content-delivery modality 305 that is different from, and hence mutually non-compatible with, the first electronic content-delivery modality 304. For example, the first electronic content-delivery modality 304 may comprise a National Television Systems Committee (NTSC)-compatible television broadcast while the second electronic content-delivery modality 305 may comprise an Internet Protocol/Transfer Control Protocol-compatible packet data streaming transmission. (Those skilled in the art will understand that these differences in modality are intended to refer to points of genuine incompatibility, such as differing types of modulation, differing packet frame structures, and so forth. Accordingly, an accommodated difference that comprises a part of a given modality's structure and makeup, such as differing carrier frequencies that can be used to receive a transmission using a same transmission standard does not rise to this level of difference.)

In such an application setting, this end user recipient platform 303 can receive a transmission of the aforementioned media source bundle 200 from, for example, a server 306 that is configured and arranged to carry out the aforementioned steps of providing that media source bundle and then transmitting the media source bundle to the end user recipient platform 303. Those skilled in the art will understand and recognize that such a transmission can be effected using any of a variety of known conveyance techniques and mechanisms. Examples in this regard would include mechanisms that push, from time to time or on an ad hoc basis, such content to the end user recipient platform 303 as well as mechanisms that permit the end user recipient platform 303 to pull the content from the server 306 as desired or as may otherwise be scheduled. It will also be understood that this can comprise transporting the media source bundle 200 using different network topologies as may be available in a given application setting.

As noted above, the aforementioned media source bundle can be developed external to the end user platform and then transmitted to the end user platform as desired. To support the reception of such a communication, and referring now to FIG. 4, an end user platform of choice can be configured and arranged to effect a process 400 that facilitates receiving 401 the aforementioned message that comprises, at least in part, the media source bundle as pertains to the given subject matter of interest to the end user. This process 400 then provides for using 402 this media source bundle to present information to the end user regarding content consumption options.

These content consumption options can of course comprise content as is available via the various content sources that pertain to the subject matter of interest. By one approach, for example, this can comprise using relationship information as may be contained within the media source bundle to form the information to present to the end user. This can comprise, for example, determining whether to present a given content consumption option and/or determining a particular order in which to present the content consumption options. To illustrate, this might comprise grouping content options by semantic similarity notwithstanding differences with respect to content delivery modalities, media type, and so forth. This might also comprise, for example, presenting the content options in a sequential order that reflects a historical sequence as otherwise pertains to the content options to thereby better facilitate allowing the end user to consume the content options in a useful and meaningful order.

As another illustrative example in this regard, when the information in the media source bundle comprises metadata source locations, usage of this information can comprise retrieving such metadata and then using that information to again determine what information is presented to the end user and/or how that information is presented. And as yet another illustrative example in this regard, such usage can comprise using the contents of the media source bundle to facilitate only presenting content source options that use an electronic content-delivery modality that is presently compatibly supported by this particular end user platform. Using this approach, for example, an end user platform comprising a Web-capable cellular telephone may present different content source options to an end user as versus a television receiver in the end user's home, notwithstanding that both end user platform may receive the same media source bundle.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 5, an illustrative approach to such a platform will now be provided.

In this illustrative example, the supporting apparatus 500 can comprise a processor 501 that operably couples to a transmitter 502 and, if desired, a receiver 503 as well as to an optional memory 504. By one approach, this apparatus 500 comprises the aforementioned server 306. In such a case, the apparatus 500 is configured and arranged (via, for example, corresponding programming of the processor 501 as will be well understood by those skilled in the art) to carry out one of more of the steps, actions, and functionality as has been set forth herein. This can include, for example, providing the aforementioned media source bundle (using, for example, information regarding the various content sources and the content that is available through such content sources as may be stored, for example, in the memory 504) and transmitting that media source bundle using the aforementioned transmitter 502.

When the apparatus 500 comprises the end user platform, the processor 501 can again be configured and arranged (again via corresponding programming) to carry out the corresponding steps, actions, and functionality as has been set forth herein. This can include, for example, receiving the transmitted media source bundle using the receiver 503 and then processing that media source bundle to extract the content source information described above. That extracted information can then be used as noted herein to form corresponding information to be provided to the end user of the apparatus 500 regarding content source options as are available that are relevant to the given evinced subject matter of interest.

Those skilled in the art will recognize and understand that such an apparatus 500 may be comprised of a plurality of physically distinct elements as is suggested by the illustration shown in FIG. 5. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, those skilled in the art will understand and appreciate that a significant quantity of useful information can be effectively and efficiently made available to a wide variety of different end user platforms regarding content of interest as is available via a wide variety of content sources in any of a wide variety of media styles, format, and forms. It will be noted and appreciated that these teachings are readily leverable by a variety of existing platforms (particularly where those end user platforms are themselves partially or wholly programmable). In addition, these teachings are highly scalable and can be used in conjunction with virtually any number of content sources, content formats, delivery modalities, and so forth—in fact, as such factors increase in number and complexity, the value of these teachings may in fact increase rather than decrease. Accordingly, it will be recognized that these teachings can greatly enhance the cross-platform user experience. It will further more be appreciated that these teachings can enhance any of a variety of user experiences such as browsing by, for example, facilitating the exploration of content even in a same platform by facilitating integration of relevant content from various sources to enrich the resultant presentation opportunities in a given single device (including, but not limited, to a single device that comprises a multiple-modality platform).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one illustrative example in this regard, these teachings will readily accommodate users who move their consumption experience from one modality (such as a television broadcast) to another, different modality (such as an Internet-based carrier). For example, profiles (including but not limited to device profiles, user profiles, and the like) can be used in conjunction with information regarding the availability of specific content in a particular modality can be used to select the best suitable content to be consumed at a given time and circumstance. Rule-based approaches may be particularly useful to guide the decision making process in this regard.

We claim:

1. A method comprising:
providing a media source bundle as pertains to a given subject matter of interest to at least one end user, the media source bundle comprising, at least in part, content source locations for each of a plurality of independent content sources that each offer content regarding the given subject matter, wherein at least some of the independent content sources are associated with mutually non-compatible electronic content-delivery modalities, and wherein the media source bundle does not comprise the content itself, transmitting a message that comprises, at least in part, the media source bundle to at least one end user recipient platform.

2. The method of claim 1 wherein the mutually non-compatible electronic content-delivery modalities comprise, but are not limited to, at least two of:
a television broadcast transmission;
a radio broadcast transmission;
a packet data-based streaming video-only transmission;
a packet data-based streaming audio-only transmission;
a packet data-based streaming audio/visual transmission;
a short message service text transmission;
a packet data-based hypertext transfer markup language-based resource.

3. The method of claim 1 wherein transmitting a message that comprises, at least in part, the media source bundle to at least one end user recipient platform comprises transmitting the message to each of a plurality of platforms for a given end user.

4. The method of claim 1 wherein providing the media source bundle comprises, at least in part, providing the media source bundle in response to prompting from at least one of:
the end user;
a content service provider;
a party affiliated with the subject matter.

5. The method of claim 1 wherein the media source bundle further comprises relationship information that characterizes a given subject matter-based relationship as between at least two items of the content, which relationship information serves to inform the end user with respect to making decisions regarding accessing particular items of the content.

6. The method of claim 5 wherein the given subject matter-based relationship comprises at least one of:
a temporally-related subject matter-based relationship;
a semantically-related subject-matter-based relationship.

7. The method of claim 1 wherein providing a media source bundle further comprises providing a media source bundle that also comprises at least one metadata source location as corresponds to at least one remote metadata source for metadata as corresponds to at least some of the content.

8. A method comprising: at an end user platform:
receiving a message that comprises, at least in part, a media source bundle as pertains to a given subject matter of interest to an end user of the end user platform, the media source bundle comprising, at least in part, content source locations for each of a plurality of independent content sources that each offer content regarding the given subject matter, wherein at least some of the independent content sources are associated with mutually non-compatible electronic content-delivery modalities, and wherein the media source bundle does not comprise the content itself;
using the media source bundle to present information to the end user regarding content consumption options.

9. The method of claim 8 wherein the mutually non-compatible electronic content-delivery modalities comprise, but are not limited to, at least two of:
a television broadcast transmission;
a radio broadcast transmission;
a packet data-based streaming video-only transmission;
a packet data-based streaming audio-only transmission;
a packet data-based streaming audio/visual transmission;
a short message service text transmission;
a packet data-based hypertext transfer markup language-based resource.

10. The method of claim 8 wherein receiving a message that comprises, at least in part, the media source bundle comprises receiving the message at each of a plurality of end user platforms for the end user.

11. The method of claim 8 wherein the media source bundle further comprises relationship information that characterizes a given subject matter-based relationship as between at least two items of the content.

12. The method of claim 11 wherein using the media source bundle to present information to the end user regarding content consumption options comprises, at least in part, using the relationship information to form the information to present to the end user.

13. The method of claim 12 wherein the given subject matter-based relationship comprises at least one of:
a temporally-related subject matter-based relationship;
a semantically-related subject-matter-based relationship.

14. The method of claim 8 wherein receiving a message comprising a media source bundle further comprises receiving a media source bundle that also comprises at least one metadata source location as corresponds to at least one remote metadata source for metadata as corresponds to at least some of the content.

15. The method of claim 14 wherein using the media source bundle to present information to the end user regarding content consumption options further comprises, at least in part, using the metadata source locations to retrieve metadata that is then used to form the information to present to the end user.

16. The method of claim 8 wherein using the media source bundle to present information to the end user regarding content consumption options further comprises, at least in part, using the media source bundle to only present options to the end user regarding content sources that use an electronic content-delivery modality that is compatibly supported by the end user platform.

17. An apparatus comprising:
a processor configured and arranged to form a media source bundle as pertains to a given subject matter of interest to at least one end user, the media source bundle comprising, at least in part:
content source locations for each of a plurality of independent content sources that each offer content regarding the given subject matter, but wherein the media source bundle does not comprise the content itself,
means for characterizing content to facilitate usage of content provided by the independent content sources by an end user platform;
a transmitter operably coupled to the processor and being configured and arranged to transmit a message that comprises, at least in part, the media source bundle to at least one end user recipient platform.

18. The apparatus of claim 17 wherein at least some of the independent content sources are associated with mutually non-compatible electronic content-delivery modalities, and wherein the means for characterizing content comprises information regarding an electronic content-delivery modality as corresponds to each of at least some of the content sources.

19. The apparatus of claim 18 wherein the means for characterizing content further comprises relationship information that characterizes a given subject matter-based relationship as between at least two items of the content, which relationship information serves to inform the end user with respect to making decisions regarding accessing particular items of the content.

20. The apparatus of claim 19 wherein the given subject matter-based relationship comprises at least one of:
a temporally-related subject matter-based relationship;
a semantically-related subject-matter-based relationship.
